(19) United States
(12) Patent Application Publication
(10) Pub. No.: US 2025/0181670 A1
(43) Pub. Date: Jun. 5, 2025

(54) ARBITRARY PRECISION NOMOGRAPHIC ANALYTICAL CALCULATION APPLICATION SPECIFIC INTEGRATED CIRCUIT

(71) Applicant: Timothy Grant Hall, Miami Beach, FL (US)

(72) Inventor: Timothy Grant Hall, Miami Beach, FL (US)

(21) Appl. No.: 18/524,639

(22) Filed: Nov. 30, 2023

(51) Int. Cl. G06F 17/18

(52) U.S. Cl. CPC G06F 17/18

(57) ABSTRACT

A system, method, and processor architecture for an arbitrary precision nomographic analytical calculation application specific integrated circuit (APNACASIC) is provided. The APNACASIC uses a set of stacked dynamic electrically erasable programmable read-only nomographic grid layers to calculate (output) an arbitrarily-precise evaluation of an arbitrary mathematical function at an arbitrarily closely-separated discrete set of domain values (input).

### BACKGROUND OF THE INVENTION

The present invention relates to processor architecture and, more particularly, to an Arbitrary Precision Nomographic Analytical Calculation Application Specific Integrated Circuit (APNACASIC).

Modern computers have become increasingly powerful computational machines that use many different systems and architectures to perform calculations with varying speed and efficiency. Such systems and architectures may include arithmetic logic units (ALUs), floating-point units (FPUs), application specific integrated circuits (ASICs), specialized integrated circuits, non-volatile read-only memory (ROM), erasable programmable read-only memory (EPROM), electrically erasable read-only memory (EEPROM), and dynamic electrically erasable read-only memory (DEEPROM), among others. However, most modern computer systems require significant computational resources for sufficiently complex equations. Thus, mathematical shortcuts and approximations are often used to help ALUs, FPUs, ASICs and other systems perform more efficiently. However, such approximations still get bogged down the more complex a calculation is being performed. This can lead to issues not just in terms of speedy calculations, but also overheating of hardware as complex calculations force conventional systems to pull more electrical current for longer periods of time to complete complex calculations.

Nomograms are graphical means for calculating solutions for mathematical equations. Since their invention, nomograms have been useful tools for quickly determining unknown variables with unparalleled efficiency and accuracy in specific applications when pocket calculators or other computing devices are unavailable or too costly to use. While nomograms are not used as often now due to the rise of personal computers, smartphones, and other powerful calculating devices, the principles underlying nomograms are still useful for providing quick and efficient calculations.

As can be seen, more efficient and accurate computational architecture is needed for the increasingly complex equations and systems being used to run the modern world. The present invention solves these issues by providing an Arbitrary Precision Nomographic Analytical Calculation Application Specific Integrated Circuit (APNACASIC) that utilizes principles of nomographic calculations to provide simplified, efficient, and accurate means for calculating solutions to complex equations.

### SUMMARY OF THE INVENTION

In one aspect of the present invention, a non-transitory computer-readable storage medium storing a computer-executable program for executing a method of calculating arbitrarily precise solutions to mathematical functions is provided. The method comprises receiving a mathematical function; receiving an input value for the mathematical function; receiving an absolute calculation error threshold; generating at least one nomographic grid layer based upon the mathematical function; calculating a rational number output of the mathematical function based upon the input value and stored linkages between layers of the at least one nomographic grid layer; calculating an absolute calculation error of the rational number output; comparing the absolute calculation error of the rational number output to the absolute calculation error threshold; wherein when the absolute calculation error of the rational number output is within the absolute calculation error threshold, a final output value is generated, and when the absolute calculation error of the rational number output is outside of the absolute calculation error threshold, the steps of generating a nomographic grid layer, calculating a rational number output, and calculating an absolute calculation error of the rational number output are repeated until the absolute calculation error is within the absolute calculation error threshold.

In another aspect of the present invention, the method executed by the non-transitory computer-readable storage medium storing a computer-executable program further comprises the step of calculating a rational number output further comprising: stacking layers of the at least one nomographic grid layer; sequentially adding the stored linkages of adjacent layers of the at least one nomographic grid layer to generate an intermediate result; and adding the intermediate result to a sequentially subsequent intermediate result until the rational output number is generated.

In another aspect of the present invention, a system is provided. The system comprises at least one processor configured to calculate an arbitrarily precise solution to a mathematical function and output the arbitrarily precise solution as a rational numerical value using stored linkages in at least one nomographic grid layer and limiting an absolute calculation error of the rational numerical value; a memory coupled to the at least one processor such that the at least one processor may access and execute executable program stored in the memory, wherein the memory further comprises: a layer parameter list comprising a dynamic record for storing information on changes to be made to the at least one nomographic grid layer at any point during an operation of the at least one processor; an initialization record for storing a combination and order of nomographic grid layers from the at least one nomographic grid layer to calculate the rational numerical value of the mathematical function; an assignment record for storing indices of particular layers of the at least one nomographic grid layer, with the particular layers being used to calculate the rational numerical values; a supplemental record for storing at least one input level of precision and at least one output level of precision; an intermediate record for storing data and information calculated or produced in calculating at least one intermediate rational numerical value, with the at least one intermediate rational numerical value only used in a subsequent calculation of another intermediate rational numerical value or the rational numerical value, and for storing a weighted average function for averaging intermediate rational numerical values; and calculation submodules that sequentially process an input value and the intermediate rational numerical values to generate the rational numerical value, the calculation submodules comprising: an input layer submodule that receives the input value; an input quantization submodule that quantizes the input value as a rational number to the at least one input level of precision stored in the supplemental record to limit an absolute calculation error of the rational numerical value; a nomographic grid accumulator submodule that sequentially adds together the stored linkages of adjacent nomographic grid layers of the at least one nomographic grid layer in accordance with the initialization record and as indexed in the assignment record to generate the at least one intermediate rational numerical value; an output quantization submodule that quantizes the last sequentially generated intermediate rational numerical value to the output level of precision stored in the supplemental record to limit an absolute calculation error of the rational numerical value and to generate an output value; and an output reduction submodule that expresses the output value as the rational numerical value.

In another aspect of the present invention the memory of the system further comprises a library of arithmetic and conversion algorithms for the calculation submodules, wherein the arithmetic and conversion algorithms: perform the arithmetic operations on the stored linkages of the at least one nomographic grid layer to produce the at least one intermediate rational numerical value; perform the quantization operations on the input value and at least one intermediate rational numerical value to produce the rational numerical value; and perform the output reduction operation to produce the rational numerical value.

In another aspect of the present invention, the system of claim further comprises an error handling submodule that detects errors within the calculation submodules, and when the operation of the calculation submodules cannot continue, the error handling submodule immediately sends a coded error message as the output value; or when the operation of the calculation submodules can continue, the error handling submodule corrects the errors by performing at least one of: a replacement of the error in the calculation submodules with corresponding information from the layer parameter lists, a reload of the stored linkages of the at least one nomographic grid layer in the calculation submodules, and a selective alteration of a value of information being processed within one of the calculation submodules.

In another aspect of the present invention, a method of calculating arbitrarily precise solutions to mathematical functions. The method comprises receiving a mathematical function; receiving an input value for the mathematical function; receiving an absolute calculation error threshold; generating at least one nomographic grid layer based upon the mathematical function; calculating a rational number output of the mathematical function based upon the input value and stored linkages between layers of the at least one nomographic grid layer; calculating an absolute calculation error of the rational number output; comparing the absolute calculation error of the rational number output to the absolute calculation error threshold; wherein when the absolute calculation error of the rational number output is within the absolute calculation error threshold, a final output value is generated, and when the absolute calculation error of the rational number output is outside of the absolute calculation error threshold, the steps of generating a nomographic grid layer, calculating a rational number output, and calculating an absolute calculation error of the rational number output are repeated until the absolute calculation error is within the absolute calculation error threshold.

In another aspect of the present invention, the method further comprises the step of calculating a rational number output further comprising: stacking layers of the at least one nomographic grid layer; sequentially adding the stored linkages of adjacent layers of the at least one nomographic grid layer to generate an intermediate result; and adding the intermediate result to a sequentially subsequent intermediate result until the rational output number is generated.

In another aspect of the present invention the method further comprises, prior to the step of calculating a rational number output, altering the stored linkages in the at least one nomographic grid layer based upon the intermediate result.

In another aspect of the present invention, the method further comprises determining the necessity of a subgroup of the at least one nomographic grid layer, and selectively voiding at least a portion of the stored linkages in the subgroup to increase calculation speed.

In another aspect of the present invention, the method further comprises: detecting an error during a calculation of the rational number output; producing an error message as the rational number output when calculation of the rational number output is no longer feasible; and when calculation of the rational number output is still feasible, correcting the error by doing at least one of: replacing the error with corresponding information from a dynamic record of the stored linkages between layers of the at least one nomographic grid layer; reloading the stored linkages of the at least one nomographic grid layer; and selectively changing the values of at least one piece of information being processed during the calculation of the rational number output.

These and other features, aspects and advantages of the present invention will become better understood with reference to the following drawings, description, and claims.

### BRIEF DESCRIPTION OF THE DRAWINGS

FIG. 1 shows a table comparison of capabilities and functionalities between prior art computational architectures (i.e., ALU, FPU, Other) and the computational architecture of the present invention (i.e., APNACASIC);

FIG. 2 depicts a diagrammatic overview of an embodiment of a computational architecture of the present invention;

FIG. 3 depicts a diagram of input quantification logical flow in accordance with an embodiment of a computational architecture of the present invention;

FIG. 4 depicts a 23×23 nomographic grid (NG) with input/output binary hierarchy in accordance with an embodiment of a computational architecture of the present invention;

FIG. 5 depicts an exemplary quantized input paired to quantized output in a 23×23 NG in accordance with an embodiment of a computational architecture of the present invention;

FIG. 6 depicts exemplary function linkages in a level l=12⁸×2⁸ NG in accordance with an embodiment of a computational architecture of the present invention;

FIG. 7 depicts exemplary function linkages in a level (>12¹⁶×2¹⁶ NG in accordance with an embodiment of a computational architecture of the present invention;

FIG. 8 depicts a diagram of NG value accumulation logical flow in accordance with an embodiment of a computational architecture of the present invention;

FIG. 9 depicts a diagram of output quantization logical flow in accordance with an embodiment of a computational architecture of the present invention;

FIG. 10 depicts a diagram of output reduction logical flow in accordance with an embodiment of a computational architecture of the present invention; and

FIG. 11 depicts a diagram of greater common divisor methodology in accordance with an embodiment of a computational architecture of the present invention.

### DETAILED DESCRIPTION OF THE INVENTION

The techniques of the present disclosure are illustrated as being implemented in a computing device such as a PC, laptop, tablet, smartphone or other device capable of executing computer-executed instructions stored on a non-transient medium, e.g., memory, such as RAM, ROM, EPROM, flash memory and so on. Thus, the execution of steps in a process flow is by way of computer-execution of such steps, e.g., via a processor configured to retrieve the corresponding instructions from memory and execute them.

The following detailed description is of the best currently contemplated modes of carrying out exemplary embodiments of the invention. The description is not to be taken in a limiting sense but is made merely for the purpose of illustrating the general principles of the invention, since the scope of the invention is best defined by the appended claims.

The system and platform of the present invention may include at least one computer with access provided thereto by a user interface. The computer may include at least one processing unit coupled to a form of memory. The computer may include, but is not limited to, a microprocessor, a server, a desktop, laptop, and smart device, such as, a tablet and smart phone. The computer includes a program product including a machine-readable program code for causing, when executed, the computer to perform steps. The program product may include systemic software which may either be loaded onto the computer or accessed by the computer. The loaded systemic software may include an application on a smart device. The systemic software may be accessed by the computer using a web browser. The computer may access the systemic software in part or entirely via the web browser using the internet, extranet, intranet, host server, internet cloud and the like.

Broadly, one embodiment of the present invention is an Arbitrary Precision Nomographic Analytical Calculation Application Specific Integrated Circuit (APNACASIC) that comprises an electronic microprocessor architecture that uses a set of stacked dynamic electrically erasable programmable read-only nomographic grid (NG) layers to calculate (output) an arbitrarily-precise evaluation of an arbitrary mathematical function at an arbitrarily closely-spaced discrete set of domain values (input). The APNACASIC NGs are stacked arrays of dynamic electrically erasable programmable read-only stored linkages (DEEPROSL) that store the analytical information used to calculate mathematical function values at any domain value for an arbitrarily-large library of mathematical functions whose algorithmic definitions are stored in the APNACASIC itself.

By virtue of the present invention's architecture, i.e., the number of stacked arrays (depth of the NGs), the number of mathematical functions, and the levels of precision available in any calculation, the present invention's capabilities and functionality far exceed the capabilities and functionalities found in the prior art. This architecture allows for the evaluation of multiple mathematical functions and their inverses, as well as arbitrarily-complicated algorithms (through repeated use in arbitrary order of the implemented mathematical functions), in one completely configurable and flexible integrated circuit.

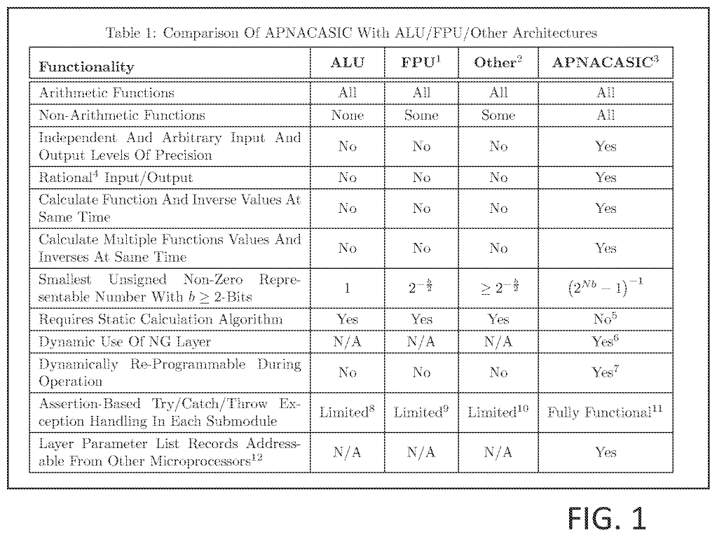

Referring now to the Figures, FIG. 1 provides a comparison of the present invention APNACASIC architecture and prior art systems. As can be seen in FIG. 1, the APNACASIC is a significant improvement and advancement over all ALUs, FPUs (with an IEEE-754 standard exponential offset, wherein IEEE-754 is the Institute of Electrical and Electronics Engineers (IEEE) standard for floating point arithmetic), and other embedded analytical calculation capabilities, designs and implementations found in the prior art (including auxiliary mathematical subroutines encoded within an integrated circuit, third-party specialized analytical units, and all such hybrid support subunits). The present invention's coverage of all functionalities found in all prior art designs, e.g., ALUs and FPUs, provides for the significant improvement of the present invention. Further, the present invention's unique approach to arbitrary-precise calculations through rational arithmetic and conversions (which have no calculation error), flexibility in application to arbitrarily-complicated mathematical function calculation algorithms, and the ability to calculate an arbitrarily large number of mathematical functions values and their inverse values in one dynamically-changeable and electrically erasable set of NGs show the present invention's superiority over the prior art.

Among other improvements, the present invention also provides superior diagnostic exception handling as part of the logical flow of each submodule, and minimizes the number of clock cycles needed to complete a calculation without the need for specialized hardware or external control systems. Each prior art architecture is limited in its ability to handle assertion-based try/catch/throw handling in a given submodule (e.g., ALUs handle over/under-flow numeric conditions only, FPUs handle an over/under-flow, division by 0, non-standard numeric format only). By comparison, the APNACASIC architecture of the present invention handles an unlimited number of numeric and logical exception circumstances, including all available in the prior art architectures.

In other words, the APNACASIC architecture of the present invention does everything that disparate architectures of the prior art, e.g., ALUs, FPUs, EEPROM, ASICs, must be combined in order to achieve, and does a lot more in a more efficient and flexible fashion than any other single electronic microprocessor in the prior art.

For example, when a user seeks to use and receive rational inputs and outputs, the APNACASIC architecture of the present invention is more flexible and faster than any operations that may be performed using an ALU and/or an FPU. In further examples, non-integer division is undefined in an ALU (but is included in the APNACASIC), floating-point division in an FPU is up to 60 times slower than integer multiplication in an FPU, and the APNACASIC architecture turns arbitrary divisions into two integer multiplications.

Furthermore, by strictly using rational number data rather than only dealing with integers (as all ALU are compelled to use), the APNACASIC is simultaneously superior to all ALU and FPU designs, as numbers may always be more precisely expressed as rational numbers in the APNACASIC architecture compared to any integer or floating-point version.

Prior art architectures also require a static calculation algorithm, whereas the APNACASIC architecture of the present invention does not. The APNACASIC's is explicitly constructed to allow intermediate results to potentially trigger dynamic changes in stored linkages in at least one NG layer. Further, any contiguous subregion of a NG layer may be used independently of all others (as well as independently of the whole NG layer), and a dynamic reprogramming of the APNACASIC's calculations may be deterministically triggered during any operation. Additionally, the APNACASIC architecture of the present invention may address layer parameter list records on other microprocessors when appropriate lockout functionality is enabled during APNACASIC non-error mode processing.

Although not explicitly shown in the Figures, each of the five submodules of the APNACASIC architecture has assertion-based try/catch/throw exception handling functionality to unilaterally abort processing in the APNACASIC with an appropriate error code sent as the final output (as a regular part of the APNACASIC output). In this respect the APNACASIC always returns some value as the final output-either the arbitrarily-precise calculated value of a mathematical function, the inverse of the arbitrarily-precise calculated value of the mathematical function at an input value, or a coded error message.

Before APNACASIC may begin operation, a dynamic change process (DCP) is conducted to make all needed changes in the stored linkages of the NGs as listed in a dynamic record (DR).

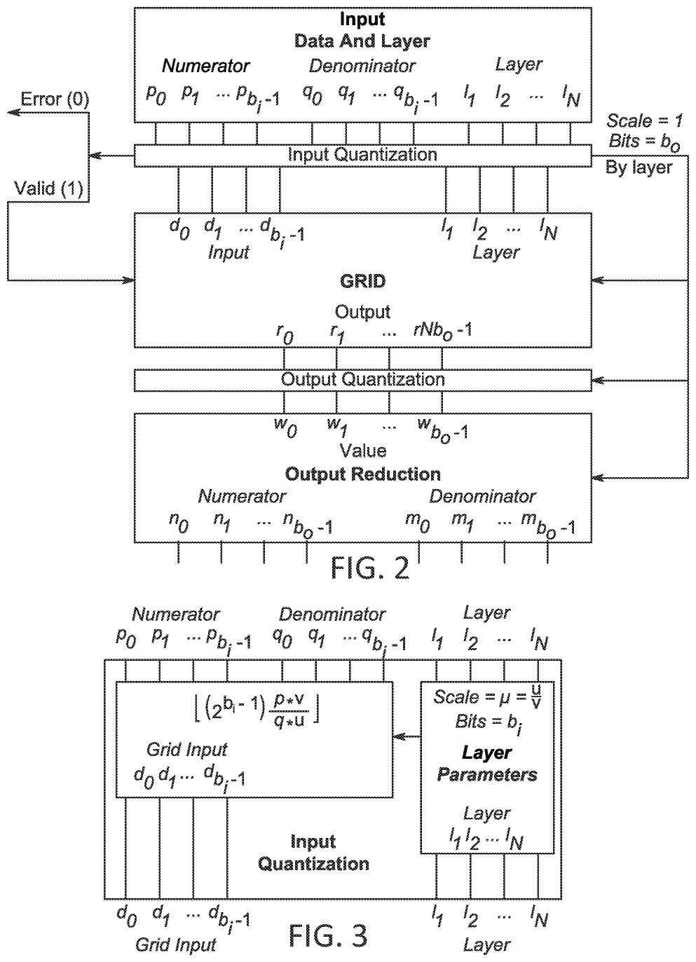

Referring to FIG. 2, an input value (IV)—a domain value of a mathematical function or its inverse expressed as the rational number p/q, which is a bᵢ-bit binary nonnegative integer numerator and a bᵢ-bit binary positive integer denominator—in the interval

$$[ 0 , μ \leq \frac{u}{v} ]$$

at which the mathematical function or its inverse is to be evaluated (where u/v is a rational number that arbitrarily-closely approximates the domain upper bound for the mathematical function or its inverse), along with the information provided by a layer parameter list (LPL) encoded as a N+1-bit binary positive integer, are received in an input data and layer (IDL) submodule. The LPL provides all information needed to complete the calculation of the mathematical function at the IV to within the levels of precision contained in the LPL. This information is collectively passed to an input quantification (IQ) submodule.

q Referring to FIG. 3, if the IV p/q is “off-grid,” the IQ submodule chooses the two closest “on-grid” nonnegative integer values that are most immediately below and above the IV, taking into account a scale factor. Analytically this is calculated according to formula

$$⌊ ( {2}^{{b}_{i}} - 1 ) \frac{p * v}{q * u} ⌋ ,$$

as best seen in FIG. 3. For example if

$${b}_{i} = 3 , μ = 1 = \frac{u}{v} , and IV = \frac{p}{q} = \frac{1}{3} ,$$

then the chosen two closest “on-grid” values are 2/7 and 3/7, since

$$\frac{2}{7} < \frac{1}{3} < \frac{3}{7} .$$

These two values are passed to a nomographic grid (NG) submodule, and the difference between the IV and the lower “on-grid” value is stored in an intermediate record. Note that if the IV p/q is already “on-grid,” then only one value is passed to the NG submodule, namely, the IV itself, and nothing additional is stored in the intermediate record.

An NG is a stacked set of two-dimensional 2^{b}^{₀}×2^{b}^{ᵢ}-arrays (read vertically, then horizontally) of perpendicular lines, each layer of which corresponds to an input value (the vertical lines) or an output value (the horizontal lines). Each of the stacked layers is configured independently of all other layers, and together they form a three-dimensional stack. When speaking of an NG Layer or NG numbered level, the reference is to an individual two-dimension array in the three-dimensional stack.

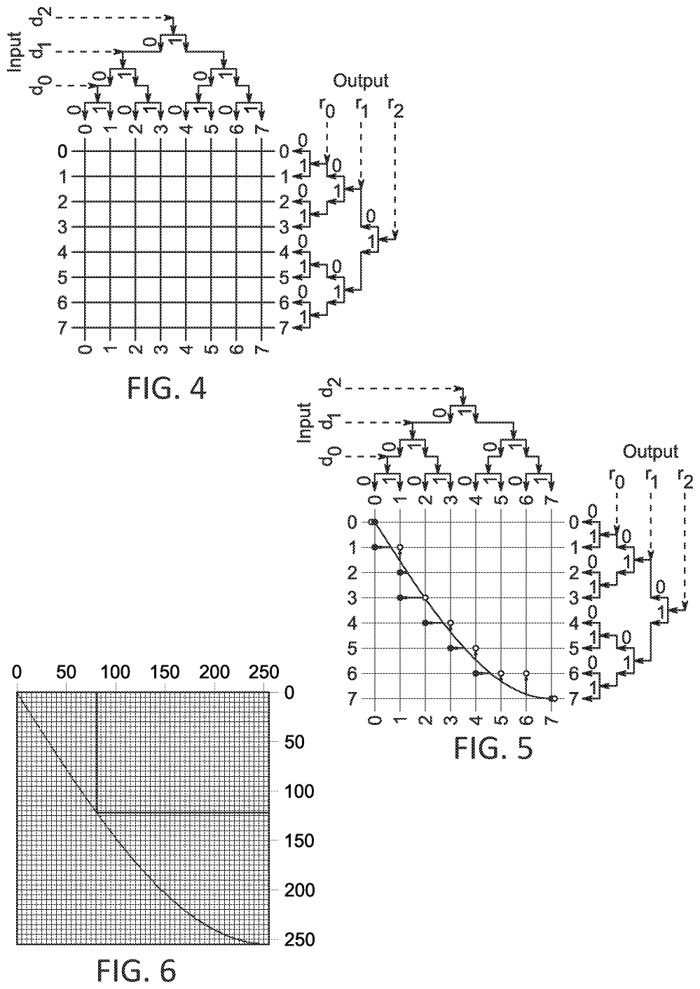

FIG. 4 demonstrates an NG (without pairings/stored linkages) with its input/output binary hierarchy when both the input and output quantization is set to 3-bit binary integers.

The particular paired intersections on a layer between input (vertical) and output (horizontal) stores a part of the analytical relationship for the mathematical function to be calculated. For example, if the mathematical function is y=ƒ(x)=x² and bᵢ=3=b₀, then on each NG layer corresponding to the mathematical function, the vertical line corresponding to

$$x = \frac{3}{7} ,$$

i.e., where the input big-endian coding is {110}, is paired with the horizontal line corresponding to

$$y = \frac{1}{7} ( since \frac{1}{7} < \frac{9}{49} < \frac{2}{7} ) .$$

All other intersections with the vertical line are void.

When calculating the inverse mathematical function, say ƒ⁻¹(y)=\sqrt{y}, with bᵢ=3=b₀, then on each NG Layer the horizontal line corresponding to

$$y = \frac{4}{7} ,$$

I.e., where the input big-endian coding is {001}, is paired with the vertical line corresponding to

$$x = \frac{5}{7} ( since \frac{5}{7} < \sqrt{\frac{4}{7}} < \frac{6}{7} ) .$$

All other intersections with the horizontal line are void. It is important to note that NG layers for a mathematical function are not the same as the NG layers for an inverse mathematical function, i.e., there are no NG layers in common. If output values (calculated anytime during APNACASIC processing) for both the mathematical function and its inverse are required during a single APNACASIC use, then both the NG layers for the mathematical function and the NG layers for the inverse mathematical function must be accessed separately.

When the mathematical relationship between x and ƒ(x), or between y and ƒ⁻¹(y), are not exact as rational numbers, such as when storing the relationship for ƒ⁻¹(y=5), then only a portion of the exact value is stored in a first NG layer, and additional NG layers are used to store additional portions of the exact value. For example, when the mathematical function is y=ƒ(x)=x² and bᵢ=3=b₀, and on each NG layer corresponding to the mathematical function, the vertical line corresponding to

$$x = \frac{3}{7}$$

is paired with the horizontal line corresponding to

$$y = \frac{1}{7} ,$$

the non-exact value of

$$y = \frac{1}{7}$$

is stored instead of the exact value of

$$y = \frac{9}{49} .$$

In another example, when the mathematical function is ƒ⁻¹(y)=\sqrt{y}, with bᵢ=3=b₀, and on each NG layer the horizontal line corresponding to

$$y = \frac{4}{7}$$

is paired with the vertical line corresponding to

$$x = \frac{5}{7} ,$$

the non-exact value of

$$x = \frac{5}{7}$$

is stored instead of the exact value of

$$x = \sqrt{\frac{4}{7}} .$$

A list of which NG layers to use to retrieve these stored values, and in which order they should be accumulated, is provided in an LPL assignment record. The level of precision in the final result from adding together (accumulating) these pieces of the exact value depends on the number of NG layers used in the calculation. It is important to note that some mathematical function values cannot be fully recovered in a finite number of NG layers. However, the APNACASIC of the present invention may provide more and more precise calculated values by using more and more NG layers, which in turn would render any absolute calculation error to be closer and closer to 0 as more NG layers are used. Thus, the APNACASIC of the present invention may provide any user with as precise a calculation as is practically necessary.

FIG. 5 presents an exemplary NG with pairings/linkages. The curve represents the exact values of a continuous function as the function's domain values range from 0/7 through 7/7. The arrows extending horizontally or vertically from the curve represent the present invention's movement of the exact value at each vertical line to the closest horizontal line that is less than the exact value, and the present invention's movement of the exact inverse function value at each horizontal line to the closest vertical line that is less than the exact value. All NG pairings/linkages are made in the same manner regardless of the value of bᵢ or b₀.

Another exemplary NG with pairings is shown in FIG. 6. Only the quantized input and quantized output values for a mathematical function are shown for each vertical line paired with a horizontal line. As an example, for a vertical line corresponding to an input value of 81/255, the NG pairs the vertical line with a horizontal 255′ line corresponding to an output value of 122/255.

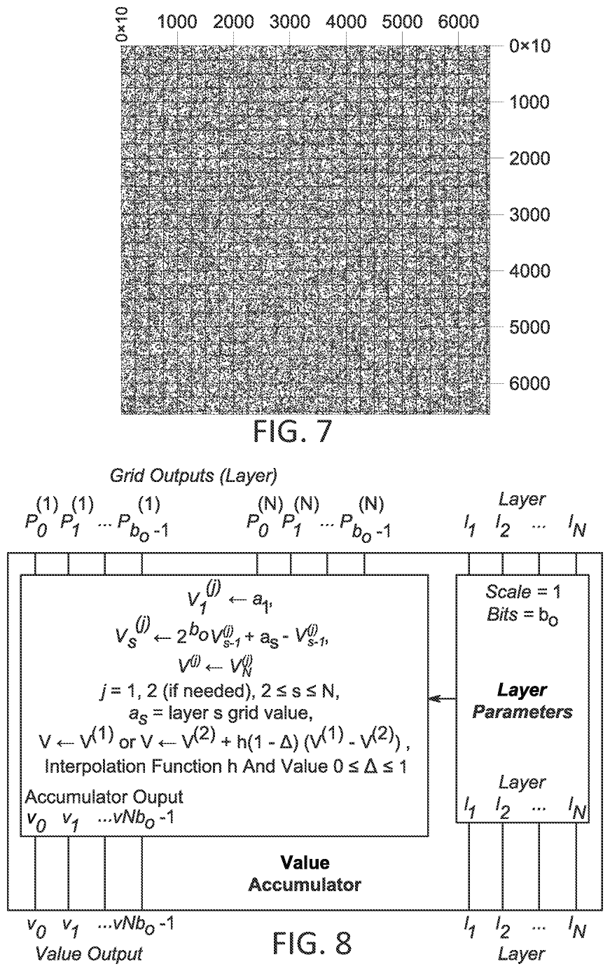

The exemplary NG shown in FIG. 6 shows a level 1 NG, i.e., the first layer, since the function in question has continuously changing values. However, additional NG layers, used to meet the required level of precision specified in an LPL supplemental record by a user or by using a default setting, have pairings representing the additional value contributed in each layer to accumulate to a final output, and these value(s), necessarily positive, do not necessarily universally follow any particular pattern. FIG. 7 presents an example NG layer (whose level is greater than 1) with input/output pairings shown by points for a 16-bit binary input and output level of precision.

It is important to note that the APNACASIC of the present invention need not utilize an entire NG layer for every mathematical function. For example, if a less-precise, i.e., lower level of output precision, calculated value for one mathematical function is sufficient to be combined with the calculated value of a different mathematical function at a higher level of output precision, then the APNACASIC may use a subgroup of an NG layer to calculate the former value to the lower level of output precision. Furthermore, the values of bᵢ and b₀ may be adjusted within the APNACASIC to produce a very high level of output precision using only a few NG layers if the adjustment aligns the IV to the bᵢ partition, with a corresponding alignment of the final value to the b₀ partition. For example, with bᵢ=32=b₀, if the domain value for a mathematical function is “off-grid” when bᵢ=32 but “on-grid” when bᵢ=12, and the resulting calculated value is “off-grid” for b₀=32, but “on-grid” when b₀=19, then using a 2¹⁹×2¹² subregion of the entire 2³²×2³² NG layer would produce a final value with a very low absolute calculation error using a much lower number of NG levels than when using the entire NG layer at each level. This feature of the APNACASIC is also very valuable when the “off-grid” versus “on-grid” considerations merely make the “on-grid” alignment more likely, i.e., more so than when using the entire NG layer, or simply closer to the “on-grid” values than otherwise. The subregion use information (if any) is stored in the LPL assignment record.

When a paired output value is retrieved by the APNACASIC from an NG layer (as specified in the LPL assignment record), the paired output value is added to other paired output values previously retrieved by the APNACASIC; this accumulation takes place in an NG accumulator within the NG Submodule. FIG. 8 discloses the formulation of the accumulator steps.

After all stored linkages from the NG layers have been accumulated, i.e., added up as a rational number, there operation has two potential outcomes: (1) only one quantized IV from the IQ submodule is passed to the NG Submodule, which happens when the IV is “on-grid,” or (2) two quantized IVs are passed, which happens when the IV is “off-grid.” In outcome (1), only one accumulated value is passed to an output quantization (OQ) submodule; in outcome (2), a weighted average of two accumulated intermediate values is calculated according to a weight function stored in the intermediate record. The calculation of the intermediate values and the weighted average (if needed) is shown in FIG. 8. However, in either outcome (1) or outcome (2), only one intermediate value is passed to the OQ submodule (either the single value from outcome (1) or the weighted average of outcome (2)).

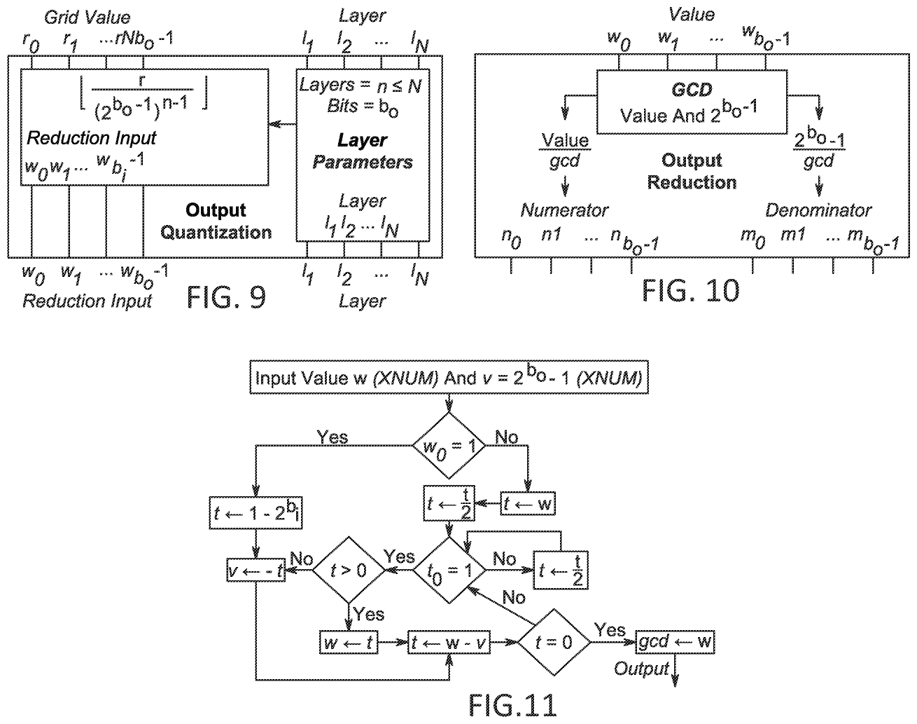

As best seen in FIG. 9, the OQ submodule receives the intermediate value expressed as a single Nb₀−1-bit binary integer from the NG submodule. Only the numerator is needed from the intermediate value, since the denominator is necessarily the b₀−1-bit binary integer value of (2b₀−1)ⁿ⁻¹, where n≤N is the actual number of NG layers (levels) that were used in the NG accumulator. The quantized output value is then passed to an output reduction submodule, where, once again, only the numerator is needed, i.e., the quantized b₀-bit binary integer, since the denominator used in the output reduction submodule is necessarily 2^{b}^{₀}−1.

With reference to FIG. 10, the output reduction submodule converts the rational number whose numerator is provided by the output quantization submodule and whose denominator is necessarily 2^{b}^{₀}−1. The conversion of this rational number to its completely reduced form is accomplished by dividing the numerator and the denominator by their greatest common divisor, which is calculated within output reduction submodule as documented in FIG. 10. The output from the output reduction submodule is the arbitrarily-precise calculated final value of the mathematical function or its inverse at the IV.

Thus, the present invention allows for the evaluation of multiple mathematical functions and their inverses, as well as arbitrarily-complicated algorithms, in one completely configurable and flexible integrated circuit. The present invention utilizes principles of nomographic calculations to provide simplified, efficient, and accurate means for calculating solutions to complex equations. The present invention enables users to find reliable and usable solutions of all manner of equations and mathematical relationships faster and more easily than prior art microprocessor architectures.

It should be understood, of course, that the foregoing relates to exemplary embodiments of the invention and that modifications may be made without departing from the spirit and scope of the invention as set forth in the following claims.

What is claimed is:

1. A non-transitory computer-readable storage medium storing a computer-executable program for executing a method of calculating arbitrarily precise solutions to mathematical functions, wherein the method comprises:
receiving a mathematical function;
receiving an input value for the mathematical function;
receiving an absolute calculation error threshold;
generating at least one nomographic grid layer based upon the mathematical function;
calculating a rational number output of the mathematical function based upon the input value and stored linkages between layers of the at least one nomographic grid layer;
calculating an absolute calculation error of the rational number output; comparing the absolute calculation error of the rational number output to the absolute calculation error threshold;
wherein when the absolute calculation error of the rational number output is within the absolute calculation error threshold, a final output value is generated, and when the absolute calculation error of the rational number output is outside of the absolute calculation error threshold, the steps of generating a nomographic grid layer, calculating a rational number output, and calculating an absolute calculation error of the rational number output are repeated until the absolute calculation error is within the absolute calculation error threshold.

2. The non-transitory computer-readable storage medium storing a computer-executable program of claim 1, wherein the method further comprises:
the step of calculating a rational number output further comprising:
stacking layers of the at least one nomographic grid layer;
sequentially adding the stored linkages of adjacent layers of the at least one nomographic grid layer to generate an intermediate result; and
adding the intermediate result to a sequentially subsequent intermediate result until the rational output number is generated.

3. A system comprising:
at least one processor configured to calculate an arbitrarily precise solution to a mathematical function and output the arbitrarily precise solution as a rational numerical value using stored linkages in at least one nomographic grid layer and limiting an absolute calculation error of the rational numerical value;
a memory coupled to the at least one processor such that the at least one processor may access and execute executable program stored in the memory, wherein the memory further comprises:
a layer parameter list comprising a dynamic record for storing information on changes to be made to the at least one nomographic grid layer at any point during an operation of the at least one processor;
an initialization record for storing a combination and order of nomographic grid layers from the at least one nomographic grid layer to calculate the rational numerical value of the mathematical function;
an assignment record for storing indices of particular layers of the at least one nomographic grid layer, with the particular layers being used to calculate the rational numerical values;
a supplemental record for storing at least one input level of precision and at least one output level of precision;
an intermediate record for storing data and information calculated or produced in calculating at least one intermediate rational numerical value, with the at least one intermediate rational numerical value only used in a subsequent calculation of another intermediate rational numerical value or the rational numerical value, and for storing a weighted average function for averaging intermediate rational numerical values; and
calculation submodules that sequentially process an input value and the intermediate rational numerical values to generate the rational numerical value, the calculation submodules comprising:
an input layer submodule that receives the input value;
an input quantization submodule that quantizes the input value as a rational number to the at least one input level of precision stored in the supplemental record to limit an absolute calculation error of the rational numerical value;
a nomographic grid accumulator submodule that sequentially adds together the stored linkages of adjacent nomographic grid layers of the at least one nomographic grid layer in accordance with the initialization record and as indexed in the assignment record to generate the at least one intermediate rational numerical value;
an output quantization submodule that quantizes the last sequentially generated intermediate rational numerical value to the output level of precision stored in the supplemental record to limit an absolute calculation error of the rational numerical value and to generate an output value; and
an output reduction submodule that expresses the output value as the rational numerical value.

4. The system of claim 3, wherein the memory further comprises a library of arithmetic and conversion algorithms for the calculation submodules, wherein the arithmetic and conversion algorithms:
perform the arithmetic operations on the stored linkages of the at least one nomographic grid layer to produce the at least one intermediate rational numerical value;
perform the quantization operations on the input value and at least one intermediate rational numerical value to produce the rational numerical value; and
perform the output reduction operation to produce the rational numerical value.

5. The system of claim 3 further comprising an error handling submodule, wherein the error handling submodule:
detects errors within the calculation submodules, and when the operation of the calculation submodules cannot continue, the error handling submodule immediately sends a coded error message as the output value; or
when the operation of the calculation submodules can continue, the error handling submodule corrects the errors by performing at least one of:
a replacement of the error in the calculation submodules with corresponding information from the layer parameter lists,
a reload of the stored linkages of the at least one nomographic grid layer in the calculation submodules, and
a selective alteration of a value of information being processed within one of the calculation submodules.

6. A method of calculating arbitrarily precise solutions to mathematical functions, wherein the method comprises:
receiving a mathematical function;
receiving an input value for the mathematical function;
receiving an absolute calculation error threshold;
generating at least one nomographic grid layer based upon the mathematical function;
calculating a rational number output of the mathematical function based upon the input value and stored linkages between layers of the at least one nomographic grid layer;
calculating an absolute calculation error of the rational number output; comparing the absolute calculation error of the rational number output to the absolute calculation error threshold;
wherein when the absolute calculation error of the rational number output is within the absolute calculation error threshold, a final output value is generated, and when the absolute calculation error of the rational number output is outside of the absolute calculation error threshold, the steps of generating a nomographic grid layer, calculating a rational number output, and calculating an absolute calculation error of the rational number output are repeated until the absolute calculation error is within the absolute calculation error threshold.

7. The method of claim 6, wherein the method further comprises:
the step of calculating a rational number output further comprising:
stacking layers of the at least one nomographic grid layer;
sequentially adding the stored linkages of adjacent layers of the at least one nomographic grid layer to generate an intermediate result; and
adding the intermediate result to a sequentially subsequent intermediate result until the rational output number is generated.

8. The method of claim 7, wherein the method further comprises:
prior to the step of calculating a rational number output, altering the stored linkages in the at least one nomographic grid layer based upon the intermediate result.

9. The method of claim 8, wherein the method further comprises:
determining the necessity of a subgroup of the at least one nomographic grid layer, and selectively voiding at least a portion of the stored linkages in the subgroup to increase calculation speed.

10. The method of claim 7, wherein the method further comprises:
detecting an error during a calculation of the rational number output;
producing an error message as the rational number output when calculation of the rational number output is no longer feasible; and
when calculation of the rational number output is still feasible, correcting the error by doing at least one of:
replacing the error with corresponding information from a dynamic record of the stored linkages between layers of the at least one nomographic grid layer;
reloading the stored linkages of the at least one nomographic grid layer; and
selectively changing the values of at least one piece of information being processed during the calculation of the rational number output.
